(19) United States
(12) Patent Application Publication
(10) Pub. No.: US 2005/0008900 A1
(43) Pub. Date: Jan. 13, 2005

(54) Substrate for magnetic recording medium

(76) Inventors: Masatoshi Ishii, Takefu-shi (JP); Toshihiro Tsumori, Takefu-shi (JP); Yu Hamaguchi, Takefu-shi (JP)

Correspondence Address: MYERS BIGEL SIBLEY & SAJOVEC, PO BOX 37428, RALEIGH, NC, 27627, US

(21) Appl. No.: 10/886,119

(22) Filed: Jul. 7, 2004

(30) Foreign Application Priority Data
Jul. 10, 2003 (JP) 2003-194783
Jul. 10, 2003 (JP) 2003-194786

(51) Int. Cl. G11B 5/64; G11B 5/667

(52) U.S. Cl. 428/694 T; 428/900; 428/694 TR; 428/409

(57) ABSTRACT

Provided are a surface-treated substrate for a magnetic recording medium which has uniform properties with regards to film formation above a non-magnetic substrate and can contain thick film, and the magnetic recoding medium comprising a recording layer. More specifically, it has been found that it is effective that the surface-treated substrate for the magnetic recording medium comprises a non-magnetic substrate and a primer plating layer disposed on the non-magnetic substrate wherein the non-magnetic substrate has been subjected to hydrophilic treatment. It has been also found that a magnetic recording medium comprising the surface-treated substrate for a magnetic recording medium, a soft magnetic layer and a recording layer is preferable as a perpendicular magnetic recording medium. Furthermore, it has been found that it is effective that the surface-treated substrate for a magnetic recording medium comprises a non-magnetic substrate and a primer plating layer on the non-magnetic substrate wherein a surface of the non-magnetic substrate comprises dimple shapes of a diameter at least 50 nm and less than 1000 nm, and of a depth less than the diameter.

### BACKGROUND OF THE INVENTION

1. Field of the Invention

The present invention relates to a magnetic recording medium which comprises a substrate for a magnetic recording medium and a recording layer.

2. Description of the Related Art

In the field of magnetic recording, information recording by hard disk devices is indispensable for primary external recording devices for computers, such as personal computers for example. As the recording densities of hard disk drives increase, the development of perpendicular magnetic recording types in which even higher density recording is possible is advancing, replacing the conventional longitudinal magnetic recording types of hard disk drives.

In perpendicular magnetic recording, the magnetic field from adjacent bits is in the same direction as the magnetizing direction, forming a closed magnetic circuit between adjacent bits, and there is less self-reducing magnetic field (referred to below as a “diamagnetizing field”) caused by self magnetization than in horizontal magnetic recording, stabilizing the magnetizing condition.

In perpendicular magnetic recording there is no particular necessity to make the magnetic film thin with increases in recording density. From these points, the perpendicular magnetic recording can reduce the diamagnetizing field and secure KᵤV values, wherein Kᵤ represents anisotropic energy, in particular the crystalline magnetic anisotropic energy in the case of magnetic recording, and V expresses the volume of a unit recording bit. Accordingly, it has stability against magnetization by thermal fluctuations and is believed to be a recording method that makes it possible to push the recording limit significantly upward. As recording media, perpendicular recording media have a high affinity with horizontal recording media, and it is possible to use basically the same technology as was used conventionally and in both reading and writing of magnetic recording.

Perpendicular magnetic recording media comprise a soft magnetic lining layer (typically of permalloy or the like), a recording film (for which candidate materials are CoCr-based alloy, multi-layer films of alternating laminated layers of PtCo layers and ultra thin films of Pd and Co, and SmCo amorphous film), a protective layer, and a lubricating layer, formed on a substrate. It is necessary that the lining layer of the perpendicular magnetic recording medium is soft magnetic, and has a film thickness of about 100 nm to about 500 nm. As well as being the path for magnetic flux from the recording film above it, the soft magnetic lining layer is also the path for the writing flux from the recording head. Because of this, it play the same role as an iron yoke in the magnetic circuit of a permanent magnet so that it is required to be a thick film.

Compared to formation of non-magnetic Cr-based primer film in a horizontal recording medium, it is not a simple matter to form the soft magnetic lining film of the perpendicular recording medium. Ordinarily, the films constituting a horizontal recording medium are all formed by a dry process (principally by magnetron sputtering) (Japanese Patent Provisional Publication No. 5-143972/1993). Film formation by dry processing has been investigated for perpendicular recording media as well. However, from the aspect of mass-production and productivity, there are large problems with film formation by dry processing because of process stability, the complexity of parameter settings, and more than anything else, process speed. Furthermore, for the purpose of achieving higher densities, it is necessary to make the height at which the head floats above the surface of the magnetic disk (the flying height) as low as possible. Accordingly, in the manufacture of the perpendicular magnetic recording medium, it is necessary to cover the substrate with a metal film of such a thickness that it can be leveled by grinding. However, because the adhesion of thick film obtained by a dry process is low, leveling by grinding is very problematic. Thus, various tests were performed to cover a non-magnetic substrate with a metal film by a plating method, with which a thick film can be formed more easily than by vacuum deposition.

In order to perform plating with favorable adhesion by wet process plating, it is very important that material which can act as a catalyst for reducing metal ions in the plating solution exists in large quantities at junction sites between the plating film and the base material. Furthermore, the adhesive strength between the plating film which is formed and the plated substrate depends on a mechanical anchoring effect due to unevenness of the surface of the plated substrate, or on chemical interactions between the plated substrate and the plating film.

For example, in order to plate the surface of a material which is poor in chemical reactivity, such as plastic, ceramics or glass, a method for securing adhesion based on mechanical anchoring is widely used, wherein colloidal particles are fixed to indented portions of the surface by dipping the substrate into a Pd—Sn colloidal solution after roughening the surface of the substrate by polish or the like, and plating is carried out using these adhered colloids as catalytic starting points.

On the other hand, when plating a surface of metal such as Fe or the like, metallic bonds are formed between the plating film and the plated metal immediately after starting the plating, and it is believed that strong adhesion is ensured by generation of an alloy at the atomic layer level.

On the other hand, the surface of a silicon wafer used as the plating substrate is water repellent, is partially dry, and is deactivated by being covered by a natural oxide film of SiO₂ which is of low chemical activity. For this reason, it is difficult to form chemical bonds with the plating film. Furthermore, there were problems that the surface of the silicon wafers after surface treatment is water repellent, is partially dry, and that non-uniform film is formed in the plain.

It is widely known that the natural oxide film of the Si surface can be dissolved for removal by soaking in HF or the like. However, the surface of the Si which has had its natural oxide film removed oxidizes very easily, so that before the plating film can be formed, the oxide film is formed again by reaction with OH groups in the solution when it is soaked in the plating solution. Consequently, a favorable plating film cannot be obtained.

Because of this, when plating a Si substrate, plating is carried out by soaking in a Pd—Sn colloid after roughening the surface of the substrate in a similar manner to that previously described when plating plastic or the like. Alternatively, it can be performed by plating a metal layer formed by vapor phase deposition such as sputtering.

However, in the process of plating after roughening the substrate, if the adhesivity of the plating layer is to be increased, it is necessary to increase the roughness of the surface of the substrate accordingly. Consequently, it is not suitable for plating a semiconductor wafer or the like used in electronic materials or the like. Furthermore, if the substrate surface is roughened by mechanical processing, marks from the process are generated, and depending on the dimensions and shape of the marks, the problem of a considerable loss of substrate strength occurs.

### SUMMARY OF THE INVENTION

It is an object of a first aspect of the invention to provide a surface-treated substrate for a magnetic recording medium which has uniform properties with regards to film formation above a non-magnetic substrate and can contain thick film, and the magnetic recoding medium comprising a recording layer.

As a result of repeated keen investigations into a surface-treated substrate for a magnetic recording medium which has uniform properties with regards to film formation above a non-magnetic substrate and can contain thick film, a soft magnetic layer and a magnetic recording medium comprising a recording layer, the inventors of the invention has found that in order to achieve the object described above, it is effective to provide a surface-treated substrate for a magnetic recording medium comprising a non-magnetic substrate and a primer plating layer on the non-magnetic recording substrate, wherein the surface of the non-magnetic substrate has been hydrophilically treated. The inventors of the invention have found that it is preferable that this hydrophilic treatment is an alcohol treatment or a hydrogen peroxide solution treatment. The inventors of the invention have also found that the magnetic recording medium comprising the substrate for a magnetic recording medium, a soft magnetic layer and recording layer is preferable as a perpendicular recording medium.

According to the first aspect of the invention, the non-magnetic substrate whose surface has been hydrophilically treated, has favorable uniformity with regard to film formed on or above this substrate. Thus, it can provide a surface-treated substrate for a magnetic recording medium which can contain thick film.

It is an object of a second aspect of the invention to provide a surface-treated substrate for a magnetic recording medium which has adhesion strong enough to withstand the leveling process of polishing or the like when forming film above a non-magnetic substrate and which can contain thick film, and the magnetic recording medium comprising a recording layer.

As a result of repeated keen investigation into a surface-treated substrate for a magnetic recording medium which can contain thick film having adhesion to a non-magnetic substrate, a soft magnetic layer and a magnetic recording medium comprising a recording layer, the inventors of the invention have found that in order to achieve the object described above it is effective to provide a surface-treated substrate for a magnetic recording medium comprising a non-magnetic substrate and a primer plating layer disposed on the non-magnetic substrate wherein preferably the entire surface of non-magnetic substrate comprises dimple shapes with a diameter of at least 50 nm and less than 1000 nm, and a depth of less than the diameter. It has been found that the dimple shapes having a depth of at least 0.1 nm and at most 100 nm may be particularly preferable. Furthermore, it is also possible to further provide a soft magnetic layer disposed on or above the primer plating layer.

Adhesion between the non-magnetic substrate and the primer plating layer increases due to the surface of the non-magnetic substrate having predetermined dimple shapes. Consequently, it is possible to provide a surface-treated substrate for a magnetic recording medium which has adhesion strong enough to withstand the leveling process by polishing or the like, and which can contain thick film.

### BRIEF DESCRIPTION OF THE DRAWINGS

FIG. 1 shows a cross-sectional view of a perpendicular magnetic recording type hard disk medium, which is an example of the invention.

FIG. 2 is a photograph of a surface of a Si monocrystalline substrate of Example 3 taken with an electron microscope.

FIG. 3 is a photograph of a surface of a Si monocrystalline substrate of Example 4 taken with an electron microscope.

### DETAILED DESCRIPTION OF THE PREFERRED EMBODIMENTS

By forming a primer plating layer for converting a highly adhesive material prior to forming film above a non-magnetic substrate, it is possible to obtain a soft magnetic film having favorable adhesion without performing unnecessary substrate surface roughening or various surface-activation treatments or the like. In addition, because the invention can be performed by wet process of electroless displacement plating, the process is greatly simplified and has excellent productivity compared to the process for forming primer layer by a vapour deposition method or the like. Furthermore, the primer plating layer has exceedingly favorable characteristics as primer film because the surface activity of the primer plating film after film formation is high, and continuous plating is possible without performing special activating steps.

There may be no particular limitations to the substrate used in the invention provided it is a non-magnetic substrate. The non-magnetic substrate may be subjected to surface-treatment with nickel phosphorous plating in advance. The non-magnetic substrate may be one on which plating is possible.

The non-magnetic substrate of the invention may be particularly preferably of Si monocrystalline material manufactured by the CZ (Czochralski) process or the FZ (Floating Zone) method. The surface orientation of the substrate may be any orientation, including for example (1 0 0), (1 1 0) or (1 1 1). Furthermore, the non-magnetic substrate may contain one or more elements such as B, P, N, As and Sn as impurity in the substrate, in a total content of 0 to 10²² atoms/cm². However, when multicrystalline Si having different crystal orientations on the same substrate surface, or Si having excessively localized distribution of impurities is used as a substrate, the primer plating layer which is formed thereon may be non-uniform because of differences in chemical reactivity. Furthermore, if a substrate having extreme localization is used, it may become impossible to achieve the primer plating layer structure as described in the invention because a local battery is produced in the localized portion of the substrate surface during formation of primer plating layer.

In the invention, the preferable activation for formation of the primer plating layer may be carried out by etching slightly the surface oxide film and the substrate surface of the non-magnetic substrate such as the Si substrate. In the invention, it is preferable to etch with an aqueous alkali solution of preferably 2 to 60 wt % caustic soda or the like so as to remove the surface oxide layer as well as to corrode slightly the substrate surface. At this time, the etching speed to achieve activation of the base material may be preferably 20 nm/min to 5 μm/min, and as the etched amount, it may be preferable to remove at least 40 nm of base material Si. Although the temperature of the fluid during etching may differ with concentration and treatment time, a range of 30 to 100° C. may be preferable from the point of operability.

According to a second aspect of the invention, as a result of keen investigation into this etching and the non-magnetic substrate before and after the etching, the inventors have found a noticeable improvement in adhesion of the primer plating layer when preferably the entire surface of the non-magnetic substrate has dimple shapes with a diameter of at least 50 nm and less than 1000 nm, and a depth less than the diameter. The depth of the dimple shape is preferably at least 0.1 nm and at most 100 nm. The dimple shape is a small depression whose size can be measured by an electron microscope. It may be preferable that the small depressions are formed regularly over the entire surface of the non-magnetic substrate, and it may be preferable that the ratio of depressed portion to non-depressed portion is (1 to 100):1.

The non-magnetic substrate having a dimple shape can form film on the non-magnetic substrate where the film has favorable adhesion so that it can withstand the leveling process of polishing or the like. It may be because the contact area between the surface of the non-magnetic substrate and the primer plating layer is increased. Furthermore, it may be because the non-magnetic substrate just after the etching is difficult to be dried, although the reason is not yet clear, so that the reaction which forms the primer plating layer proceeds favorably.

According to the first aspect of the invention, the non-magnetic substrate which has been etched is hydrophilically treated. The hydrophilic treatment may be preferably performed using alcohol or a solution of hydrogen peroxide solution.

The alcohol may preferably include monool or polyol having 1 to 5 carbons such as ethylene glycol, ethanol and isopropyl alcohol. The hydrogen peroxide solution may be preferably an aqueous solution of 1 to 20 wt %. A hydrogen peroxide solution having pH values of 9 to 12 obtained by addition of ammonia water may also be preferable.

Hydrophilic treatment can be carried out for example by soaking or washing the non-magnetic substrate in alcohol or a hydrogen peroxide solution after etching. The preferable hydrophilic treatment time and temperature may be 15 to 80° C. for 30 seconds to 10 minutes, more preferably 20 to 40° C. although it differs with the number of pieces to be treated and volume of treatment solution.

The non-magnetic substrate which has been hydrophilically treated increases adhesion with respect to the primer plating layer formed on them, and give a favorable uniformity to film formation on or above the non-magnetic substrate. This may be caused during formation of the primer plating layer, due to the hydrophilic pretreatment, by the plating solution completely covering the outermost surface of the non-magnetic substrate, or by the plating solution having favorable recirculation.

After the etching, or preferably after the additional hydrophilic treatment, a highly adhesive plating material can be obtained by forming a surface layer. The surface layer may be produced by soaking in a plating solution containing at least 0.01 N and preferably of 0.05 to 0.3 N of at least one metal ion selected from the group consisting of Ag, Co, Cu, Ni, Pd and Pt, or of one or more elemental components where said metal ion is contained as a principal metal ion. The thickness of this primer plating layer may be preferably 10 to 1000 nm, more preferably 50 to 500 nm. When the layer is less than 10 nm thick, uniform distribution of multi-crystalline particles may not be obtained. When over 1000 nm, the crystalline particles may swell and may not be suitable as a primer film.

It may be preferable that film formation is performed by the method generally known as electroless displacement plating. Although use of a solution which does not contain a component which can act as a reducing agent such as hypophosphoric acid and hypochloric acid is the same as in conventional displacement plating, it may be particularly preferable in the invention to use a sulfate salt bath which does not contain a component serving as a glossing agent such as saccharin. Examples of the sulfate salt may include nickel sulfate and copper sulfate. The sulfate salt may be preferably present at concentration of 0.01 to 0.5 N. A hydrochloric acid bath, or a bath containing 0.05 N or more chloride ion may not be preferable. It is not only because it may be difficult to obtain the primer plating layer of the invention, but also because there may be cases in which plating onto the Si substrate itself becomes impossible. Furthermore, for the purpose of accomplishing the invention, it may not be preferable to have each element such as K, Ca or Na present in the solution at level of 0.003 N or more. Consequently, chloride ion may be limited to less than 0.05 N, and each of K, Ca, Na or the like may be limited to less than 0.003 N in the solution.

As the plating condition of the invention, a bath temperature may be 70 to 100° C. and the pH of the solution may be in a range of 7.2 to 12.8, more preferably 7.6 to 8.4. When the temperature of the plating solution is less than 70° C., plating may not be possible. When the plating solution is above 100° C., or the pH is outside the range described above during plating, plating itself may be possible, but the primer plating film according to the invention may be unobtainable. It may be preferable that pH is controlled by addition of ammonia. If pH control is performed by hydroxide such as caustic soda, it is problematic to work the invention even if the pH is within the range described above. Although the reason for this is not completely clear, it seems very important that the metallic ion in the solution can form complex ion with a complex forming agent such as ammonia.

Although the amount of ammonia to be added can be adjusted in accordance with the initial pH, it is also possible to add the ammonia to the plating solution in a range of 0.02 to 0.5 N, preferably in a range of 0.05 to 0.2 N.

The primer plating layer can be formed by combined use of the etching treatment and primer plating treatment described above.

A soft magnetic layer can be formed on or above the primer plating layer of the invention. The soft magnetic layer may not be particularly limited and may include any material known in the art. The soft magnetic layer may preferably comprise one or more selected from the group consisting of Fe, Co, Ni, P, Nb, Zr, B, V and the like and the example thereof includes permalloy (Fe₈₀Ni₂₀).

It is also possible to use any method known in the art as the soft magnetic layer forming method without limitation, for example sputtering.

The thickness of the soft magnetic layer may fluctuate with the conditions of the application and use, and may be for example, 100 to 1000 nm, preferably 100 to 500 nm.

The magnetic recording medium of the invention may be preferably a perpendicular magnetic recording medium. The magnetic recording medium of the invention may comprise a non-magnetic substrate, a primer plating layer and a soft magnetic layer. The soft magnetic layer may be a single layer, or may comprise a multi-layer body constituted by a plurality of films. According to the invention, it is preferable that the primer plating layer and the soft magnetic layer are formed by wet plating. By forming these layers using wet plating, it is possible to obtain exceedingly favorable characteristics in which the process is simplified with excellent productivity, activity is maintained and continuous film formation is possible.

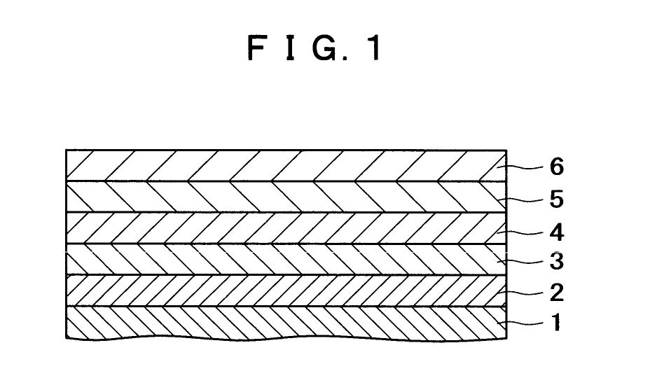

FIG. 1 shows an example of the perpendicular magnetic recording type hard disk medium of the invention. The substrate for the magnetic recording medium of the invention comprises a nonmagnetic substrate 1, a primer plating layer 2 and a soft magnetic layer 3. It can provide the magnetic recording medium comprising a recording layer 4 on the soft magnetic layer 3. Furthermore, a protective layer 5 and a lubricating layer 6 can be formed on or above the recording film. These layers can be formed using methods known in the art, such as sputtering or the like.

An example of a recording layer may include a Co recording layer is, an example of a protective layer may include a carbon protective layer, and an example of a lubricating layer may include a fluorine based lubricating layer. That is to say, the recording layer, the protective layer and the lubricating layer can be as known in the art. The thickness of these layers can fluctuate with application and conditions of use.

According to the invention, the soft magnetic layer and the recording layer may be provided on a single side or both sides of the substrate.

The invention will be explained based on the working examples below, however the present invention is not limited to these.

### EXAMPLE 1

Both surfaces of a (1 0 0) Si monocrystal (P doped N type substrate) having a diameter of 65 mm which had been produced by cutout, edge-removal and lapping of a 200 mm diameter Si monocrystalline substrate fabricated by the CZ process, were polished with colloidal silica of an mean particle size of 15 nm so as to have a surface roughness (Rms) of 4 nm. The Rms means a mean square roughness and was measured using an AFM (Atomic Force Microscope). The Si etching was performed on the surface while the thin surface oxide film was removed from the surface of the substrate by soaking for 3 minutes in a 10 wt % aqueous caustic soda solution at 45° C. Then, this substrate was soaked in an ethylene glycol solution for one minute.

Next, a primer plating bath (solution) was prepared by adding 0.5 N of ammonium sulfate to a 0.1 N aqueous nickel sulfate solution, and the pH was brought up to 9.8 by addition of ammonia water. This solution was heated to 80° C., and when the pH was measured again, it was 7.6. While adding ammonia water continuously to bring the pH to 8.0 at 80° C. (the total amount of ammonia was 0.1 N), the primer plating layer was obtained by soaking the previously etched Si substrate in the primer plating solution for 5 minutes.

Investigation of the film of this material by fluorescent X-ray analysis and transmission electron microscope, a uniform primer plating layer of 200 nm±10 nm was confirmed.

### EXAMPLE 2

Si etching was performed on the surface of a Si substrate which had been obtained in the same manner as in Example 1, while the thin surface oxide film was removed from the surface of the substrate by soaking for 2 minutes in a 45 wt % aqueous caustic soda solution at 50° C. Then, the Si substrate was soaked for one minute in a 5 wt % hydrogen peroxide solution adjusted to a pH value of 9.5 by addition of ammonia water. Next, a primer plating bath was prepared by adding a 0.2 N aqueous ammonium sulfate solution to a 0.2 N aqueous copper sulfate solution, and the pH was brought up to 8.3 by addition of ammonia water. This solution was heated to 80° C., and when the pH was measured again, it was 6.9. While adding ammonia water continuously to bring the pH to 8.0 at 80° C. (the total amount of ammonia was 0.2 N), the primer plating layer was obtained by soaking the previously etched Si substrate in the primer plating bath for 7 minutes.

Investigating the film of this material by fluorescent X-ray analysis and transmission electron microscope, a uniform primer plating layer of 150 nm±6 nm was confirmed.

### EXAMPLE 3

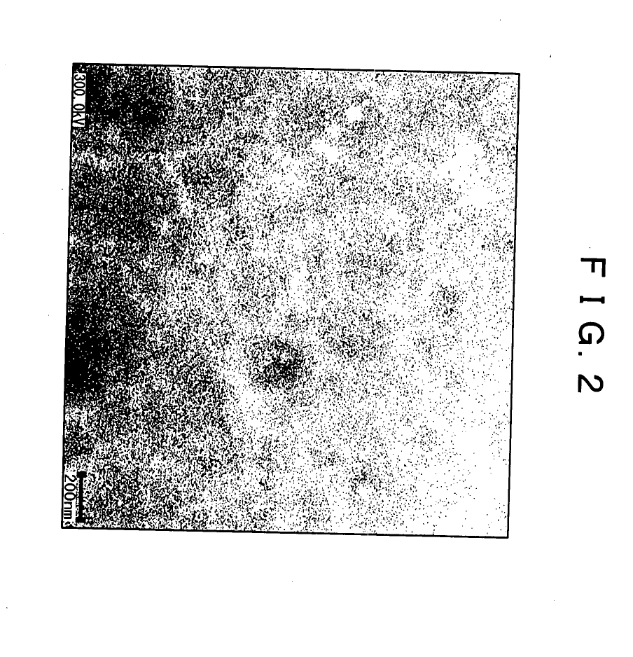

Both surfaces of a (1 0 0) Si monocrystal (P doped N type substrate) having a diameter of 65 mm which had been produced by cutout, edge-removal and lapping of a 200 mm diameter Si monocrystalline substrate fabricated by the CZ process, were polished with colloidal silica of a mean particle size of 15 nm so as to have a surface roughness (Rms) of 4 nm. The Rms means a mean square roughness and was measured using an AFM (Atomic Force Microscope). Si etching was performed on the surface while the thin surface oxide film was removed from the surface of the substrate by soaking for 3 minutes in a 10 wt % aqueous caustic soda solution at 45° C. Inspecting the surface of this material by electron microscope, dimple shapes of an average diameter of 200 nm and an average depth of 50 nm were observed (see FIG. 2).

Next, a primer plating bath was prepared by adding 0.5 N of ammonium sulfate to a 0.1 N aqueous nickel sulfate solution, and the pH was brought up to 9.8 by addition of ammonia water. This solution was heated to 80° C., and when the pH was measured again, it was 7.6. While adding ammonia water continuously to bring the pH to 8.0 at 80° C. (the total amount of ammonia was 0.1 N), the primer plating layer was obtained by soaking the previously etched Si substrate in the primer plating bath for 5 minutes.

Inserting lattice-shaped cuts at 5 mm intervals into this primer plating film, sellotape (registered trade mark) was used to make a peel off test, and delamination of the plated film was not observed at all.

### EXAMPLE 4

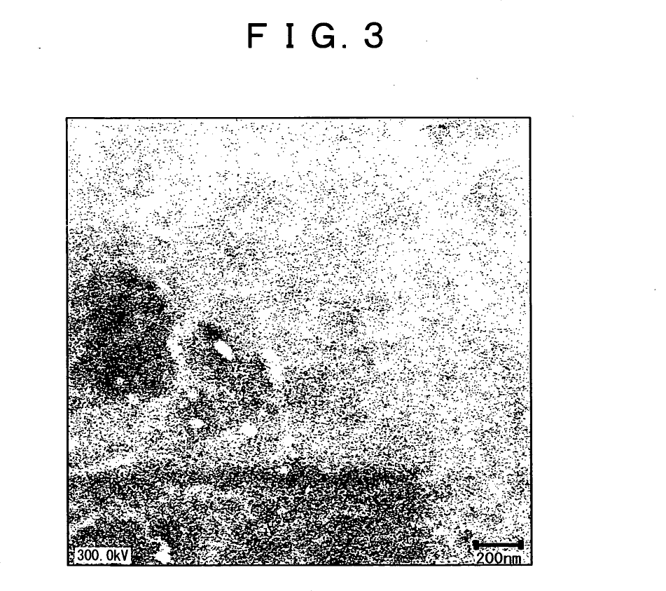

The etching was performed on the surface of the Si substrate which had been produced in the same manner as in Example 3, while the thin surface oxide film from the surface of the substrate was removed by soaking for 2 minutes in a 45 wt % aqueous caustic soda solution at 50° C. Inspecting the surface of this material by electron microscope, dimple shapes of an average diameter of 100 nm and an average depth of 30 nm were observed (see FIG. 3).

Next, a primer plating bath was prepared by adding a 0.2 N aqueous ammonium sulfate solution to a 0.2 N aqueous copper sulfate solution, and the pH was brought up to 8.3 by further addition of ammonia water. This solution was heated to 80° C., and when the pH was measured again, it was 6.9. While adding ammonia water continuously to bring the pH to 8.0 at 80° C. (the total amount of ammonia was 0.2 N), the primer plating layer was obtained by soaking the previously etched Si substrate in the primer plating bath for 7 minutes.

Inserting lattice-shaped cuts at 5 mm intervals into this primer plating film, sellotape (registered trade mark) was used to make a peel off test, and delamination of the plated film was not observed at all.

1. A surface-treated substrate for a magnetic recording medium comprising a non-magnetic substrate whose surface has been subjected to hydrophilical treatment and a primer plating layer on the non-magnetic substrate.

2. The surface-treated substrate for a magnetic recording medium according to claim 1 wherein said hydrophilic treatment is alcohol treatment or hydrogen peroxide solution treatment.

3. The surface-treated substrate for a magnetic recording medium according to claim 1 further comprising a soft magnetic layer disposed on or above the primer plating layer.

4. A magnetic recording medium comprising the surface-treated substrate for a magnetic recording medium according to claim 3 and a recording layer provided on or above the substrate.

5. A surface-treated substrate for a magnetic recording medium comprising a non-magnetic substrate and a primer plating layer on the non-magnetic substrate;
wherein a surface of the non-magnetic substrate comprises dimple shapes of a diameter at least 50 nm and less than 1000 nm, and of a depth less than the diameter.

6. The surface-treated substrate for a magnetic recording medium according to claim 5 wherein said depth of the dimple shapes is at least 0.1 nm and at most 100 nm.

7. The surface-treated substrate for a magnetic recording medium according to claim 5 further comprising a soft magnetic layer disposed on or above said primer plating layer.

8. The surface-treated substrate for a magnetic recording medium according to claim 2 further comprising a soft magnetic layer disposed on or above the primer plating layer.

9. A magnetic recording medium comprising the surface-treated substrate for a magnetic recording medium according to claim 8 and a recording layer provided on or above the substrate.

10. The surface-treated substrate for a magnetic recording medium according to claim 6 further comprising a soft magnetic layer disposed on or above said primer plating layer.
